(19) United States
(12) Patent Application Publication
(10) Pub. No.: US 2013/0073181 A1
(43) Pub. Date: Mar. 21, 2013

(54) CONTROL APPARATUS AND CONTROL METHOD FOR INTERNAL COMBUSTION ENGINE

(71) Applicant: Yusuke Mamada, Susono-shi (JP)

(72) Inventor: Yusuke Mamada, Susono-shi (JP)

(73) Assignee: TOYOTA JIDOSHA KABUSHIKI KAISHA, Toyota-shi (JP)

(21) Appl. No.: 13/617,533

(22) Filed: Sep. 14, 2012

(30) Foreign Application Priority Data
Sep. 15, 2011 (JP) 2011-201549

(51) Int. Cl. F02D 28/00

(52) U.S. Cl. 701/103

(57) ABSTRACT

A control apparatus for an internal combustion engine includes at least one air-fuel ratio detection unit; a feedback control unit configured to determine a fuel injection amount for each of cylinders by performing air-fuel ratio feedback control using a feedback control amount; a learning unit configured to learn the feedback control amount so as to obtain a learned value, and to update the learned value at an update rate; an estimation unit configured to estimate a degree of imbalance in the air-fuel ratio among the cylinders based on a detected air-fuel ratio; an initialization unit configured to initialize the learned value when a deviation between the estimated degree of imbalance and a previous value is equal to or greater than a predetermined value; and an update rate change unit configured to increase the update rate, relative to a standard value after initialization of the learned value.

### INCORPORATION BY REFERENCE

The disclosure of Japanese Patent Application No. 2011-201549 filed on Sep. 15, 2011 including the specification, drawings and abstract is incorporated herein by reference in its entirety.

### BACKGROUND OF THE INVENTION

1. Field of the Invention

The invention relates to a control apparatus and a control method for an internal combustion engine for enabling appropriate air-fuel ratio feedback (F/B) control of a fuel injection amount.

2. Description of Related Art

Japanese Patent Application Publication No. 2010-174809 (JP-2010-174809 A) describes a control apparatus for a multi-cylinder internal combustion engine which is configured to increase the update rate of learned value in air-fuel ratio F/B control when the learned value is initialized by removal of a battery, in order to promptly stabilize the learned value.

Further, Japanese Patent Application Publication No. 2007-321620 (JP-2007-321620 A) describes an air-fuel ratio control apparatus which is configured to perform determination on convergence of a learned value relating to the air-fuel ratio after reset (initialization) of the learned value in order to perform the determination on the convergence of the learned value as soon as possible.

Initialization of an air-fuel ratio learned value is also described in Japanese Patent Application Publication No. 2000-257487 (JP-2000-257487 A).

Further, Japanese Patent Application Publication No. 62-135643 (JP-62-135643 A) describes a learning control method for a vehicle engine, which relates not only to learning of air-fuel ratio learned value but also to various kinds of learning applicable to control of engine operation, and is designed such that when an abnormal learned value is found, that learned value is initialized, and when initialization is performed for such reason, normal learning is accelerated.

In so-called air-fuel ratio F/B control in which an air-fuel ratio sensor or O₂ sensor is employed, as described in the related-art examples, some of correction factors used for correction of a fuel injection amount or the like are learned while being updated as appropriate. Those learned values which are updated as appropriate in this learning processing basically continue to be used except when a contingency such as removal of a battery occurs, as described above. However, the learned values can be maintained even after such a contingency occurs, if storing means for storing the learned value is configured appropriately. Accordingly, the learned value that is lastly updated during the previous trip is continuously used also in the latest trip (as an initial value, for example).

In a multi-cylinder internal combustion engine having fuel injection devices provided in respective cylinders, the fuel injection devices have individual differences attributable to manufacturing variances, aging or the like. Therefore, an actual fuel injection amount in response to a certain drive signal often slightly differs among the cylinders. This variation in fuel injection amount becomes a factor causing imbalance in air-fuel ratio among the cylinders.

Although the degree of imbalance in air-fuel ratio is unlikely to vary significantly during one trip (for example, during a period from ignition ON to ignition OFF), it may vary significantly due to some external or internal factor between different trips. If the degree of imbalance varies in a discontinuous manner, the state of exhaust gas in an exhaust passage also varies, and a learned value of F/B control amount in the air-fuel ratio F/B control newly starts to converge toward a value corresponding to the varied degree of imbalance.

However, when viewed from the standpoint of learning processing relating to the air-fuel ratio F/B control, the variation of the degree of imbalance in air-fuel ratio between trips can be considered as a kind of disturbance, and the learned value of this learning processing is not an abnormal value. Therefore, according to the aforementioned related-art example in which no consideration is given to such imbalance in air-fuel ratio, a learned value in the previous trip may be continuously used even if significant variation has occurred in the degree of imbalance in air-fuel ratio.

However, if learning processing is performed based on a previous learned value when the state of exhaust gas changes in a discontinuous manner, the learned value relating to the F/B control amount in the air-fuel ratio F/B control cannot be converged rapidly since this previous learned value is not adequate. In consideration of the aforementioned related-art example, it is also conceivable to accelerate the learning by increasing the update rate of learned value in the case in which relatively great variation occurs in the degree of imbalance. However, if the update rate of learned value is increased when the previous learned value is not adequate, the learned value may possibly converge to a convergence value that is different from a true convergence value, or the convergence to the true convergence value may be rather delayed.

Specifically, related art technologies including those of the aforementioned examples have a technical problem that due to a fact that a relationship between imbalance in air-fuel ratio and learning processing on the F/B control amount in air-fuel ratio F/B control is not clearly defined, it is difficult to appropriately perform the learning processing when the degree of imbalance in air-fuel ratio varies significantly in a discontinuous manner.

### SUMMARY OF THE INVENTION

The invention provides a control apparatus and a control method for an internal combustion engine, which maintains the accuracy of learning in air-fuel ratio F/B control even if there is imbalance in air-fuel ratio.

A first aspect of the invention relates to a control apparatus for an internal combustion engine. The control apparatus includes at least one air-fuel ratio detection unit arranged in an area of an exhaust passage, in which exhaust gas from a plurality of cylinders of the internal combustion engine is collected; a feedback control unit configured to determine a fuel injection amount for each of the plurality of cylinders by performing predetermined air-fuel ratio feedback control including feeding back an air-fuel ratio detected by the at least one air-fuel ratio detection unit to the fuel injection amount using a feedback control amount; a learning unit configured to learn the feedback control amount relating to the air-fuel ratio feedback control so as to obtain a learned value relating to the feedback control amount, and to update the learned value at an update rate; an estimation unit configured to estimate a degree of imbalance in the air-fuel ratio among the plurality of cylinders based on the detected air-fuel ratio; an initialization unit configured to initialize the learned value when a deviation between the estimated degree of imbalance and a previous value of the estimated degree of imbalance is equal to or greater than a predetermined value; and an update rate change unit configured to increase the update rate, relative to a standard value of the update rate after initialization of the learned value.

The internal combustion engine according to the aspect of the invention is configured as a multi-cylinder internal combustion engine including a plurality of cylinders, and each of the plurality of cylinders includes an electronic controlled injector or other fuel injection device provided in its intake port, for example. Further, in an area of an exhaust passage, in which exhaust gas from the plurality of cylinders is collected (for example, an exhaust manifold to which exhaust ports of the cylinders are connected together and an exhaust pipe downstream thereof), there is provided the air-fuel ratio detection unit that detects an air-fuel ratio in the exhaust passage, for example, an air-fuel ratio sensor or O₂ sensor. Strictly speaking, the air-fuel ratio in the exhaust passage means an air-fuel ratio of gas to be detected flowing through an area where the air-fuel ratio detection unit is arranged. In consideration of the fact that the gas to be detected flows constantly from the upstream side (cylinder side) to the downstream side without stopping, the air-fuel ratio in the exhaust passage may signify a time average value of the air-fuel ratio of the gas to be detected.

There are practically various modes in which the air-fuel ratio detection unit detects the air-fuel ratio, and the air-fuel ratio detection unit may be a unit which detects a value the behavior of which has an unambiguous relationship with an air-fuel ratio, for example, a voltage value or the like that can be converted into an air-fuel ratio by predetermined conversion processing using an arithmetic expression, a map or the like. The detection unit may be arranged in various detailed manners. For example, the detection unit may be configured to include an air-fuel ratio sensor arranged upstream of an exhaust gas cleaning device such as a three-way catalyst, and an O₂ sensor arranged downstream thereof.

In the internal combustion engine according to the aspect of the invention, a fuel injection amount is determined by air-fuel ratio feedback control. The air-fuel ratio feedback control is known control in which a basic fuel injection amount is corrected as required based on an air-fuel ratio in the exhaust passage such that the air-fuel ratio of air-fuel mixture in the cylinder is maintained at a target air-fuel ratio (e.g. at a stoichiometric air-fuel ratio) at that time point, or it gradually approaches or converges to the target air-fuel ratio at that time point. The air-fuel ratio feedback control may be performed in various manners.

When the air-fuel ratio detection unit is configured as an air-fuel ratio sensor arranged upstream of the exhaust gas cleaning device in the exhaust passage, for example, the air-fuel ratio feedback control may be control in which a feedback control amount (for example, a correction factor or the like by which the basic fuel injection amount is multiplied) is calculated according to a deviation between a detected air-fuel ratio and a target air-fuel ratio, and the basic injection amount is corrected based on this feedback control amount.

Alternatively, when the air-fuel ratio detection unit is composed of a plurality of sensors arranged on the opposite sides of the exhaust gas cleaning device that is arranged in the exhaust passage, the air-fuel ratio feedback control may consist of sub feedback control using a sensor arranged downstream of the exhaust gas cleaning device (downstream-side sensor) and main feedback control using a sensor arranged upstream of the exhaust gas cleaning device (upstream-side sensor). More specifically, the sub feedback control may be such that a sub feedback control amount is calculated to maintain an air-fuel ratio detected by the downstream-side sensor (downstream air-fuel ratio) at a target air-fuel ratio or cause the downstream air-fuel ratio to gradually approach or converge to the target air-fuel ratio according to a deviation between the downstream air-fuel ratio and the target air-fuel ratio, while an air-fuel ratio detected by the upstream-side sensor (upstream air-fuel ratio) is corrected based on this sub feedback control amount. In this case, the main feedback control may be such that a main feedback control amount (for example, a correction factor by which the basic injection amount is multiplied) for maintaining the upstream air-fuel ratio at the target air-fuel ratio or causing the upstream air-fuel ratio to gradually approach or converge to the target air-fuel ratio is determined according to a deviation between the corrected upstream air-fuel ratio and the target air-fuel ratio, so that the basic injection amount is corrected.

The air-fuel ratio feedback control according to the aspect of the invention may be, for example, so-called proportional-integral (PI) control in which the feedback control amount includes a proportional term (P-term) and an integral term (I-term), or so-called proportional-integral-derivative (PID) control in which the feedback control amount includes a derivative term (D-term) in addition to a proportional term and an integral term. Further, the air-fuel ratio feedback control may be such that all the cylinders are controlled uniformly, or such that the cylinders are controlled individually.

The control apparatus for the internal combustion engine according to the aspect of the invention is an apparatus for controlling the above-described internal combustion engine, and may include a computer device or system such as an electronic control unit (ECU) which includes a central processing unit (CPU) or other processor. This computer device or system may include a storage unit such as a read only memory (ROM) or a random access memory (RAM), as appropriate.

In the control apparatus for the internal combustion engine according to the aspect of the invention, the feedback control amount relating to this air-fuel ratio feedback control (the kind of the feedback control amount varies according to a practical mode of air-fuel ratio feedback control) is learned by the learning unit.

Learning signifies a concept in which a state in the past is reflected to some extent in control which is currently performed, and the learning may be performed in various practical manners within the scope of this concept. However, the learning is desirably performed for the purpose of obtaining advantages such as improved accuracy of a control amount, shortened calculation time, and reduced calculation load in the current control (that is, the control performed at the latest time) by reflecting the state in the past. From this point of view, the learned value that is updated as necessary by the learning may be a value which corresponds to a stationary component of the feedback control amount. For example, when the air-fuel ratio feedback control is PI control or PID control as described above, the stationary component may be a value corresponding to an integral term thereof.

In the control apparatus for the internal combustion engine according to the aspect of the invention, the degree of imbalance in the air-fuel ratio among the plurality of cylinders is estimated by the estimation unit based on the detected air-fuel ratio.

The “degree of imbalance in the air-fuel ratio” as used in the aspect of the invention is a quantitative index signifying the degree of imbalance in the air-fuel ratio among the plurality of cylinders, and may assume a variety of practical forms within the scope of the concept. The degree of imbalance in the air-fuel ratio may be a single value defined for the internal combustion engine, or a value defined for each of the cylinders, according to a practical definition.

The “degree of imbalance in the air-fuel ratio” according to the aspect of the invention may include, for example, those as defined in options (1) to (3) below. The term “a value corresponding to” as used herein below is a concept including a control amount, physical amount, or an index value which has an unambiguous relationship with an object value. For example, “a value corresponding to the air-fuel ratio” may be a detected voltage value or may be a fuel injection amount, taken into account that the air-fuel ratio is used for correction of the fuel injection amount. The options are: (1) a value corresponding to a ratio of an air-fuel ratio of each cylinder to an average value of air-fuel ratios of all the cylinders; (2) a value corresponding to a ratio of an air-fuel ratio of a particular cylinder to air-fuel ratios of the remaining cylinders; and (3) a value corresponding to a maximum value of divergence amount (variation) of the air-fuel ratio among the cylinders. In terms of operation of the air-fuel ratio feedback control, the air-fuel ratio detection unit may not obtain the air-fuel ratio in the exhaust passage in association with each of the cylinders (as described above, the air-fuel ratio detection unit may obtain a time average value). However, it can be preliminarily obtained experimentally, empirically or theoretically how much time delay (that may otherwise be crank angle delay or number-of-cycle delay) is involved from when air-fuel mixture having a certain air-fuel ratio is discharged from a certain cylinder after a combustion stroke until when it reaches a space where the air-fuel ratio detection unit is arranged. Therefore, the estimation unit is able to obtain the detected air-fuel ratio in association with each of the cylinders, and necessarily is able to obtain an air-fuel ratio of each cylinder (strictly speaking, an air-fuel ratio that can be treated unambiguously as an air-fuel ratio of each cylinder). Alternatively, the estimation unit may calculate and estimate an air-fuel ratio of each cylinder from the detected air-fuel ratio in the exhaust passage according to a calculation model which is preliminarily designed experimentally, empirically, or theoretically.

In the processing of learning the feedback control amount in the air-fuel ratio feedback control in related art, no consideration is given to imbalance in the air-fuel ratio. Accordingly, the learned value relating to the feedback control amount in the previous trip continues to be effective even if there is significant difference between the imbalance in the air-fuel ratio among the cylinders in the previous trip and that in the latest trip. This is natural in view of the fact that there is no fault in the learning processing, that is, the learned value in the previous trip is a normal value.

In practical operation, however, the state of exhaust gas flowing through the exhaust passage varies significantly if there occurs a significant change in the imbalance in the air-fuel ratio. Thus, the learned value (true learned value), to which the learned value should converge in the learning processing on the feedback control amount in the air-fuel ratio feedback control, also varies significantly. If the learned value (true learned value), to which the learned value should newly converge, varies significantly, the previous learned value becomes not suitable for the current learning, and even if the learning is accelerated by increasing the learning rate, it is difficult to cause the learned value to converge rapidly to the true learned value.

More specifically, if the learning is simply accelerated, the learning history of the previous trips is reflected, whereby convergence to the true learned value is possibly delayed even more. Further, if the difference between the previous learned value and the true learned value is not so significant, the approach to the true learned value is hindered by the acceleration of the learning, and the learned value might possibly converge to a value that is different from the true learned value. This stays true regardless of whether the fuel injection amount for each of all the cylinders is uniformly determined by the air-fuel ratio feedback control or the fuel injection amount for each of the cylinders is individually determined by the air-fuel ratio feedback control.

Thus, in the control apparatus for the internal combustion engine according to the aforementioned aspect of the invention, when the deviation between the estimated degree of imbalance and the previous value of the estimated degree of imbalance is equal to or greater than the predetermined value, the learned value relating to the feedback control amount is initialized by the initialization unit. After the initialization of the learned value, the update rate (learning rate) of the learned value is updated by the update rate change unit so that the update rate becomes higher than a standard value of the update rate, that is, the update rate is increased, whereby the learning of the feedback control amount is accelerated.

The degree of imbalance in the air-fuel ratio estimated by the estimation unit is effective as an index used to understand how much the imbalance in air-fuel ratio has changed between the previous value and the latest value, and the deviation between the previous value and the latest estimated value (latest value) serves as an index used to determine whether or not the previous learned value is an adequate value for the current learning processing on the feedback control amount (for example, whether or not it is adequate as an initial value). If the deviation is too great, the current learning conditions are different significantly from the previous learning conditions, and hence it can be reasonably determined that the previous learned value should be discarded. On the other hand, if the update rate of the learned value can be increased after the learned value is initialized (the initial value may be either zero or a preset design value), the effect of accelerating the learning can be ensured.

As described above, the control apparatus for the internal combustion engine according to the aspect of the invention makes it possible, when the degree of imbalance in the air-fuel ratio varies significantly, to prevent possible delay in convergence of the learned value or deterioration in the convergence accuracy, by a technical idea in which in consideration of a possibility that the learned value obtained by the previous learning processing might impede proper progress of the latest learning processing, the learned value obtained by the previous learning processing is initialized even if it is a normal value, and the update rate of the learned value is increased after the initialization. That is, the feedback control amount in the air-fuel ratio feedback control can be learned in an appropriate manner in consideration of the imbalance in the air-fuel ratio.

In the control apparatus for the internal combustion engine according to the aspect of the invention, the internal combustion engine may include an exhaust gas cleaning device that is arranged in the exhaust passage and cleans the exhaust gas, and the air-fuel ratio detection unit may be provided in plurality, at least one of the air-fuel ratio detection units being arranged upstream of the exhaust gas cleaning device in the exhaust passage, and at least one of the air-fuel ratio detection units being arranged downstream of the exhaust gas cleaning device in the exhaust passage.

According to the aspect of the invention, at least one air-fuel ratio detection unit is provided upstream of the exhaust gas cleaning device, and at least one air-fuel ratio detection unit is provided downstream of the exhaust gas cleaning device. This enables highly accurate air-fuel ratio feedback control in which the sub feedback control and the main feedback control are combined.

When the air-fuel ratio feedback control has a plurality of feedback systems like this, learning processing can be performed in each of the feedback systems. Therefore, the influence that is exerted by any imbalance in the air-fuel ratio on the air-fuel ratio feedback control is likely to become greater when the plurality of feedback systems are provided. In this regard, the control apparatus for the internal combustion engine according to the aspect of the invention exhibits pronounced effects particularly when it is used for control of this kind of internal combustion engine.

The control apparatus for the internal combustion engine according to the aspect of the invention may further include a determination unit configured to determine whether or not the learned value has converged, wherein the update rate change unit returns the update rate to the standard value when the determination unit determines that the learned value has converged.

According to the aspect of the invention, it is determined by the determination unit whether or not the learned value after the initialization has converged, and when it is determined that the learned value has converged to a prescribed value or into a prescribed range, the update rate of the learned value in the learning processing is returned to the standard value. Accordingly, the convergence accuracy can be prevented from being deteriorated in the vicinity of the true convergence value due to excessively high update rate, whereby high accuracy learning is enabled.

In view of this respect, the “convergence” determined by the determination unit need not necessarily signify convergence to a relatively narrow range based on a true convergence value to which the learned value should converge according to the degree of imbalance at that time point, and may signify convergence to a relative wide range based on a true convergence value, in which it may be determined that learning at a standard rate is more desirable. The state of convergence based on which switching of update rate is determined can be preliminarily defined experimentally, empirically, or theoretically. For example, the determination unit may determine that the learned value has converged when a reference value for determination is exceeded by the number of times the feedback control amount is inverted during the progress of the learning processing (the number of times the increasing or decreasing tendency is switched over to the decreasing or increasing tendency), or by the number of times the air-fuel ratio is inverted (the number of times the air-fuel ratio is switched from the rich or lean side to the lean or rich side with respect to the target air-fuel ratio). When a simpler configuration is employed, the determination unit may determine that the learned value has converged when the learning period after the initialization has exceeded a reference value.

A second aspect of the invention relates to a control method for an internal combustion engine. The control method includes detecting an air-fuel ratio of exhaust gas in an area of an exhaust passage, in which the exhaust gas from a plurality of cylinders of the internal combustion engine is collected; determining a fuel injection amount for each of the plurality of cylinders by performing predetermined air-fuel ratio feedback control including feeding back the detected air-fuel ratio to the fuel injection amount using a feedback control amount; learning the feedback control amount relating to the air-fuel ratio feedback control so as to obtain a learned value relating to the feedback control amount, and to update the learned value at an update rate; estimating a degree of imbalance in the air-fuel ratio among the plurality of cylinders based on the detected air-fuel ratio; initializing the learned value when a deviation between the estimated degree of imbalance and a previous value of the estimated degree of imbalance is equal to or greater than a predetermined value; and increasing the update rate, relative to a standard value of the update rate after initialization of the learned value.

Other effects and advantages of the aspects of the invention will be clarified in the embodiments described below.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram schematically showing a configuration of an engine system according to an embodiment of the invention;

FIG. 2 is a schematic sectional view showing, by way of example, a specific configuration of an engine in the engine system shown in FIG. 1;

FIG. 3 is a flowchart of learning accuracy compensation control performed by an ECU in the engine system shown in FIG. 1; and

FIG. 4 is a timing chart showing, by way of example, time transition of various control values in a process of performing the learning accuracy compensation control shown in FIG. 3.

### DETAILED DESCRIPTION OF EMBODIMENTS

An embodiment of the invention will be described with reference to the accompanying drawings.

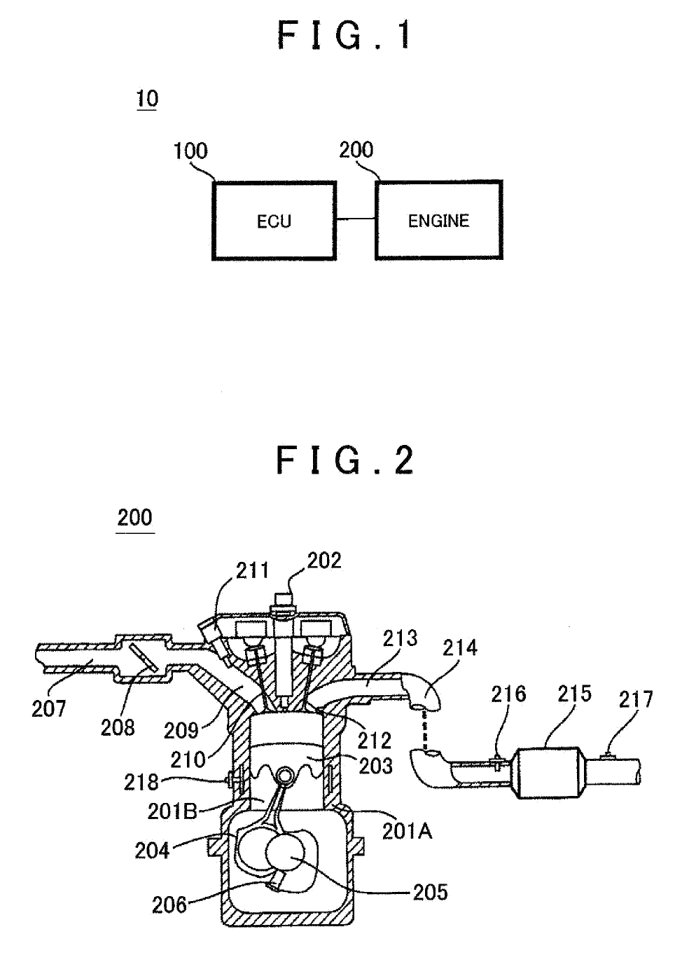

Firstly, referring to FIG. 1, a configuration of an engine system 10 according to the embodiment of the invention will be described. FIG. 1 is a block diagram schematically showing the configuration of the engine system 10.

As shown in FIG. 1, the engine system 10 is mounted on a vehicle (not shown) and has an ECU 100 and an engine 200.

The ECU 100 is an electronic control unit (ECU) having a CPU, a ROM, and a RAM, and configured to be able to control the entire operation of the engine system 10. The ECU 100 is an example of “the control apparatus for an internal combustion engine” according to the invention. The ECU 100 is configured to be able to perform learning accuracy compensation control to be described later according to a control program stored in the ROM.

It should be noted that while the ECU 100 is an integrated ECU that is capable of functioning as examples of “a feedback control unit”, “a learning unit”, “an estimation unit”, “an initialization unit”, “an update rate change unit”, and “a determination unit” according to the invention, physical, mechanical and electrical configurations of these units according to the invention are not restricted to this, and these units may be configured as a plurality of ECUs, various kinds of processing units, controllers, or computer systems such as microcomputers.

The engine 200 is a multi-cylinder gasoline engine which is an example of “an internal combustion engine” according to the invention. A detailed configuration of the engine 200 will be described with reference to FIG. 2. FIG. 2 is a schematic sectional view showing, by way of example, a specific configuration of the engine 200.

As shown in FIG. 2, the engine 200 is configured such that a mixture of air and gasoline is burned as a fuel within a cylinder 201B accommodated in a cylinder block 201A by an ignition operation performed by an ignition device 202 having an ignition plug (reference numeral omitted) a part of which is exposed into a combustion chamber, and reciprocating motion of the piston 203, which is caused in accordance with force generated by the combustion, is converted into rotational motion of a crank shaft 205 via a connecting rod 204.

A crank position sensor 206 for detecting a rotational position (i.e., crank angle) of the crank shaft 205 is arranged in the vicinity of the crank shaft 205. This crank position sensor 206 is electrically connected to the ECU 100, so that a detected crank angle of the engine 200 is referred to by the ECU 100 at constant or inconstant intervals to be used for calculation of engine speed NE or various control procedures.

While the engine 200 is an in-line 4-cylinder engine in which four cylinders 201B (an example of “a plurality of cylinders” according to the invention) are arranged in series in a direction perpendicular to the plane of the paper in FIG. 2, the following description with reference to FIG. 2 will be made in terms of only one of the cylinders 201E since the cylinders 201B have the same configuration. It should be understood that such a configuration as described here is only an example of various configurations that may be employed by the “internal combustion engine” according to the invention.

In the engine 200, air introduced from the outside is cleaned by a cleaner (not shown) and introduced into the intake pipe 207. The intake pipe 207 is provided with a throttle valve 208 which adjusts an amount of the intake air. This throttle valve 208 is configured such that its drive state is controlled by a throttle valve motor (not shown) electrically connected to the ECU 100.

While the ECU 100 basically drives and controls the throttle valve motor to obtain a throttle opening Thr in accordance with an accelerator operation amount Ta detected by an accelerator position sensor (not shown), the throttle opening may be adjusted without intervention of the driver's intention through the control of operation of the throttle valve motor. This means that the throttle valve 208 is configured as a kind of electronically controlled throttle valve.

The intake air the amount of which is appropriately adjusted by the throttle valve 208 is mixed with a fuel injected from an intake port injector 211 in an intake port 209 corresponding to each of the cylinders 201B, whereby the aforementioned air-fuel mixture is produced. The fuel is stored in a fuel tank (not shown), and is pumped and supplied to the intake port injector 211 by action of a low-pressure feed pump (not shown) through a delivery pipe (not shown).

The intake port injector 211 has a fuel injection valve (not shown) and is configured to be able to inject, into the intake port, an amount of the fuel according to a fuel injection period TAU corresponding to a period during which the fuel injection valve is open. An available and not shown drive device for driving the fuel injection valve is electrically connected to the ECU 100, so that its operation is controlled by the ECU 100.

The communication state between the inside of the cylinder 201B and the intake port 209 is controlled by opening and closing of an intake valve 210. Specifically, the air-fuel mixture is drawn into the inside of the cylinder 201B during a valve-opening period (IVO) of the intake valve 210. The air-fuel mixture which has burnt in the inside of the cylinder 201B becomes exhaust gas, which is introduced into an exhaust pipe 214 via an exhaust port 213 during opening of an exhaust valve 212 which is opened and closed in conjunction with opening and closing of the intake valve 210. The exhaust pipe 214 is an example of an “exhaust passage” according to the invention.

An available three-way catalyst 215 as an example of an “exhaust gas cleaning device” according to the invention is arranged in the exhaust pipe 214. The three-way catalyst 215 has a structure in which a catalyst carrier supports platinum or other noble metal, and is capable of cleaning exhaust gas by causing an oxidation combustion reaction of carbon monoxide CO and total hydro carbon (THC) as an unburned component, substantially at the same time with a reduction reaction of nitrogen oxide NOx.

An upstream air-fuel ratio sensor 216 is arranged upstream of the three-way catalyst 215 in the exhaust pipe 214 in order to detect an upstream air-fuel ratio A/Fin that is an air-fuel ratio of the gas flowing into the catalyst. The upstream air-fuel ratio sensor 216 is, for example, a limiting-current-type wide range air-fuel ratio sensor having a diffusion resistance layer. The “gas flowing into the catalyst” means exhaust gas which is introduced into the exhaust pipe 214 after being discharged into the exhaust ports 213 corresponding to the respective cylinders and then collected in an exhaust manifold (not shown).

The upstream air-fuel ratio sensor 216 is a sensor which outputs an output voltage Vafin according to an upstream air-fuel ratio A/Fin (that is, the sensor is configured to indirectly detect an air-fuel ratio based on a voltage value having an unambiguous relationship with the air-fuel ratio). This output voltage Vafin becomes equal to an output value Vst when the upstream air-fuel ratio A/Fin is a stoichiometric air-fuel ratio, becomes lower than the output value Vst when the upstream air-fuel ratio A/Fin is on the richer side of (lower than) the stoichiometric air-fuel ratio, and becomes higher than the output value Vst when the upstream air-fuel ratio A/Fin is on the leaner side of (higher than) the stoichiometric air-fuel ratio. This means that the output voltage Vafin varies continuously as the upstream air-fuel ratio A/Fin changes. The upstream air-fuel ratio sensor 216 is electrically connected to the ECU 100 so that the detected output voltage Vafin is referred to by the ECU 100 at constant or inconstant intervals.

A downstream air-fuel ratio sensor 217 is arranged downstream of the three-way catalyst 215 in the exhaust pipe 214, in order to detect a downstream air-fuel ratio A/Fout that is an air-fuel ratio of the catalyst exhaust gas. The downstream air-fuel ratio sensor 217 is, for example, a known electromotive force type oxygen concentration sensor (concentration cell type oxygen concentration sensor using a stabilized zirconia). The “catalyst exhaust gas” as used herein means exhaust gas directly after passing through the three-way catalyst 215. Preferably, the catalyst exhaust gas is a gas which is introduced into a downstream-side catalyst (that is usually a three-way catalyst but often differs from the three-way catalyst 215 in its noble metal supporting ratio) arranged downstream of the three-way catalyst 215.

The downstream air-fuel ratio sensor 217 is a sensor which outputs an output voltage Voxs according to a downstream air-fuel ratio A/Fout (that is, the downstream air-fuel ratio sensor 217 is configured to detect an air-fuel ratio indirectly based on a voltage value having an unambiguous relationship with the air-fuel ratio). This output voltage Voxs is equal to an output value Vim (for example, about 0.5 V) when the downstream air-fuel ratio A/Fout is a stoichiometric air-fuel ratio, and changes to a maximum value Vmax (for example, about 0.9 V) when the downstream air-fuel ratio A/Fout is on the richer side of (lower than) the stoichiometric air-fuel ratio. When the downstream air-fuel ratio A/Fout is on the leaner side of (higher than) the stoichiometric air-fuel ratio, the output voltage Voxs changes to a minimum value Vmin (for example, about 0.1 V). Unlike the upstream air-fuel ratio sensor 216, the change of the output voltage Voxs in association with the downstream air-fuel ratio A/Fout is discontinuous. When the downstream air-fuel ratio A/Fout changes from the rich side (or the lean side) to the lean side (or the rich side), the output voltage Voxs sharply changes from the maximum value Vmax (or the minimum value Vmin) to the minimum value Vmin (or the maximum value Vmax).

The downstream air-fuel ratio sensor 217 is electrically connected to the ECU 100 so that the detected output voltage Voxs is referred to by the ECU 100 at constant or inconstant intervals.

A water jacket which is arranged to surround the cylinder block 201A is provided with a coolant temperature sensor 218 for detecting a coolant temperature Tw of a coolant (Long Life Coolant (LLC)) which is circulated and supplied to cool the engine 200. The coolant temperature sensor 218 is electrically connected to the ECU 100 so that the detected coolant temperature Tw is referred to by the ECU 100 at constant or inconstant intervals.

In the engine 200, the fuel injection amount Q of the intake port injector 211 is controlled by air-fuel ratio F/B control that is constantly performed by the ECU 100 during an operating period of the engine 200. The air-fuel ratio F/B control is control in which the output voltage Vafin of the upstream air-fuel ratio sensor 216 and the output voltage Voxs of the downstream air-fuel ratio sensor 217 are fed back for correction of the fuel injection amount Q.

The air-fuel ratio F/B control includes: (1) main F/B control for matching an upstream air-fuel ratio A/Fin (more specifically, a F/B control air-fuel ratio A/Finc to be described later) obtained based on the output voltage Vafin of the upstream air-fuel ratio sensor 216 with an upstream target air-fuel ratio A/Fintg; and (2) sub F/B control for matching the output voltage Voxs of the downstream air-fuel ratio sensor 217 with a target value Voxstg.

More specifically, the ECU 100 corrects the output voltage Vafin of the upstream air-fuel ratio sensor 216 based on a sub F/B control amount Vfbs that is calculated such that a difference Dvoxs between the output voltage Voxs of the downstream air-fuel ratio sensor 217 and its target value Voxstg is decreased and a sub F/B learned value Vfbsl that is a learned value relating to the sub F/B control amount Vfbs, and calculates a F/B control air-fuel ratio A/Finc. These control procedures belong to the sub F/B control. Further, the ECU 100 controls the fuel injection amount Q by determining a main F/B control amount FAF as a correction factor to be used for correction of a basic fuel injection amount Qb such that the calculated F/B control air-fuel ratio A/Finc coincides with the upstream target air-fuel ratio A/Fintg, and then correcting the basic fuel injection amount Qb. The basic fuel injection amount Qb is a basic value of the fuel injection amount Q determined according to operation conditions of the engine. These control procedures belong to the main F/B control.

The air-fuel ratio F/B control will be described in detail below.

First, the ECU 100 calculates a F/B control output voltage Vafinc according to the following formula (1). In the formula (1), as described before, Vafin denotes the output voltage of the upstream air-fuel ratio sensor 216, Vfbs denotes a sub F/B control amount, and Vfbsl denotes a sub F/B learned value.

Vafinc=Vafin+Vfbs+Vfbsl (1)

Once the F/B control output voltage Vafinc is obtained, the ECU 100 then converts the F/B control output voltage Vafinc to a F/B control air-fuel ratio A/Finc by referring to a conversion map prestored in the ROM.

On the other hand, the ECU 100 obtains a cylinder intake air amount Mc that is an amount of air drawn into the inside of the cylinder 201B. The cylinder intake air amount Mc is calculated for every intake stroke of each of the cylinders based on an intake air amount Ga detected by an airflow meter not shown in FIG. 1 and an engine speed NE. Various known methods can be applied as the method of calculating the cylinder intake air amount Mc.

Upon obtaining the cylinder intake air amount Mc, the ECU 100 obtains the basic fuel injection amount Qb by dividing the cylinder intake air amount Mc by the upstream target air-fuel ratio A/Fintg at that time (that is basically the stoichiometric air-fuel ratio in this embodiment).

Once the basic fuel injection amount Qb is obtained, the ECU 100 then obtains the final fuel injection amount Q to be injected from the fuel injection valve of the intake port injector 211, according to the following formula (2):

Q=Qb·KG·FAF (2)

where KG denotes a main F/B learned value (a learned value relating to the main F/B control amount FAF), and FAF denotes the main F/B control amount that is updated by the main F/B control as necessary. The main F/B control amount FAF is an example of the “feedback control amount” according to the invention, and the main F/B learned value KG is an example of the “learned value” according to the invention.

The main F/B control amount FAF is calculated based on a main F/B value DF. The main F/B value DF is obtained in the following manner.

The ECU 100 obtains a cylinder fuel supply amount Qcn that is an amount of fuel supplied to the combustion chamber of the cylinder 201B at the time point N cycles before the current time point, by dividing the cylinder intake air amount Mcn at the time point N cycles (that is, N·720° CA in this embodiment) before the current time point, by the F/B control air-fuel ratio A/Finc.

The value at “N cycles before” is used because it takes time corresponding to N cycles for the air-fuel mixture that has been used for combustion processing in the combustion chamber to reach the upstream air-fuel ratio sensor 216. This means that the number of cycles N is preliminarily obtained experimentally, empirically, or theoretically. It should be noted that, however, that the gas to which the upstream air-fuel ratio sensor 216 is exposed is a gas that has not been introduced into the catalyst and is mixed to some extent with exhaust gas discharged from the cylinders.

The ECU 100 then obtains a target cylinder fuel supply amount Qcntg at the time point N cycles before by dividing the cylinder intake air amount Mcn at the time point N cycles before by the upstream target air-fuel ratio A/Fintg at the time point N cycles before (for the purpose of simplification of description, it is assumed in this embodiment that the upstream target air-fuel ratio A/Fintg is the stoichiometric air-fuel ratio which is fixed).

The ECU 100 obtains a value as a cylinder fuel supply amount deviation DFc by subtracting the cylinder fuel supply amount Qcn at the time point N cycles before, which has been previously obtained, from the target cylinder fuel supply amount Qcntg at the time point N cycles before. This cylinder fuel supply amount deviation DFc represents an amount of deficiency or excess of the fuel supplied into the cylinder at the time point N cycles before. Once the cylinder fuel supply amount deviation DFc is obtained, a main F/B value DF is obtained according to the following formula (3):

DF=(Gp·DFc+Gi·SDFc)·KFB (3)

where Gp denotes a proportional gain, and Gi denotes an integral gain. The coefficient KFB is a design value, which is set to “1” in this example. However, the coefficient KFB may be variable according to the engine speed NE, the cylinder intake air amount Mc or the like. Further, SDFc in the formula (3) above is an integral value of the cylinder fuel supply amount deviation DFc. This means that the main F/B value DF can be obtained by PI control that is a kind of known F/B control.

Once the main F/B value DF is obtained, the ECU 100 then obtains the main F/B control amount FAF according to the following formula (4):

FAF=(Qbn+DF)/Qbn (4)

where Qbn in the formula (4) above denotes a basic fuel injection amount at the time point N cycles before. This means that the main F/B control amount FAF is obtained by dividing a sum of the basic fuel injection amount Qbn at the time point N cycles before and the main F/B value DF by the basic fuel injection amount Qbn at the time point N cycles before.

The basic fuel injection amount Qb is multiplied by the main F/B control amount FAF obtained in this manner at every predetermined update timing, whereby the final fuel injection amount Q is calculated. The control procedures described so far are the main F/B control in the air-fuel ratio F/B control. The main F/B learned value KG will be described later.

Next, description will be made of a method of calculating the sub F/B control amount Vfbs (that is another example of the “feedback control amount” according to the invention) used in the formula (1) above. The ECU 100 calculates the output voltage deviation Dvoxs, at every predetermined update timing, by subtracting the output voltage Voxs of the downstream air-fuel ratio sensor 217 from the target value Voxstg of the output voltage Voxs. While the target value Voxstg of the output voltage Voxs can be determined as appropriate such that the three-way catalyst 215 is allowed to have a desirable exhaust cleaning efficiency, it is assumed in the description of this embodiment, for the purpose of avoiding complicated description, that the target value Voxstg is set to the output value Vim corresponding to the stoichiometric air-fuel ratio described above.

Once the output voltage deviation Dvoxs is obtained, the ECU 100 calculates the sub F/B control amount Vfbs according to the following formula (5). In the formula (5), Kp, Ki and Kd denote a proportional gain, an integral gain, and a derivative gain, respectively. SDvoxs and DDvoxs denote a time integral value and a time derivative value of the deviation Dvoxs, respectively.

Vfbs=Kp·Dvoxs+Ki·SDvoxs+Kd·DDvoxs (5)

In this manner, the ECU 100 performs PID control that is a kind of known F/B control, at every predetermined update timing, in order to match the output voltage Voxs of the downstream air-fuel ratio sensor 217 with the target value.

Description will be made of a method of calculating the learned value Vfbsl relating to the sub FR control amount Vfbs (that is another example of the “learned value” according to the invention) used in the formula (1) above. Every time the output voltage Voxs of the downstream air-fuel ratio sensor 217 crosses the output value Vim as the target value, the ECU 100 updates the learned value Vfbsl relating to the sub F/B control amount Vfbs according to the following formula (6). In the formula (6), (i) in the left-hand side indicates that the learned value Vfbsl is a learned value at the latest time, and (i−1) in the right-hand side indicates that the learned value Vfbsl is a learned value at the previous sampling time.

Vfbsl(i)=(1−p)·Vfbsl(i−1)+p·Ki·SDvoxs (6)

Thus, the learned value Vfbsl relating to the sub F/B control amount is a value obtained by subjecting an integral term Ki·SDvoxs of the sub F/B control amount Vfbs to filter processing for removal of noise, and is updated, at every update timing, so as to become an amount in accordance with the stationary component of the sub F/B control amount Vfbs.

In the formula (6) above, the value p is an arbitrary value that is equal to or greater than zero, and less than one. As evident from the formula (6), the integral term is reflected more on the learned value Vfbsl as the value p becomes greater. This means that as the value p is made greater, the learned value update rate Vupdt as the update rate of the learned value Vfbsl can be increased. The learned value update processing according to the formula (6) above is an example of the learning processing on the F/B control amount.

As described above, in the air-fuel ratio F/B control, the output voltage Vafin of the upstream air-fuel ratio sensor 216 is corrected by a sum of the sub F/B control amount Vfbs and the learned value Vfbsl, and the F/B control air-fuel ratio A/Finc is obtained based on the FIB control output voltage Vafinc obtained by the correction. The basic fuel injection amount Qb is then corrected such that the FIB control air-fuel ratio A/Finc thus obtained matches with the upstream target air-fuel ratio A/Fintg. As a result, the upstream air-fuel ratio A/Fin gradually approaches its target value A/Fintg, while at the same time the output voltage Voxs of the downstream air-fuel ratio sensor 217 gradually approaches the output value Vim (the value corresponding to the stoichiometric air-fuel ratio) as its target value.

Description will now be made of update processing for the main F/B learned value KG. The main F/B learned value KG is updated so as to make the main F/B control amount FAF closer to the basic value “1”.

More specifically, the ECU 100 obtains a weighted average value FAFAV of the main F/B control amount FAF according to the following formula (7) at the timing when the main F/B control amount FAF is calculated. In the formula (7), q denotes a design value that is more than zero and less than one. As described above, (i) indicates a current value and (i−1) indicates a previous value.

FAFAV(i)=q·FAF+(1−q)·FAFAV(i−1) (7)

When this weighted average value FAFAV is equal to or more than 1+α (α denotes a design value that is equal to or more than zero and less than one), the ECU 100 increases the main F/B learned value KG by a preliminarily set correction amount X. On the contrary, when the weighted average value FAFAV is equal to or less than 1−α, the ECU 100 decreases the main F/B learned value KG by the correction amount X. If the weighted average value FAFAV is in a range between 1+α and 1−α, the main F/B learned value is not updated.

When the main F/B learned value KG is updated appropriately in the course of progress of the air-fuel ratio F/B control, the weighted average value FAFAV gradually converges to a value between “1−α” and “1+α”. The number of times when the weighted average value FAFAV has fallen within this range at the update timings (the number of times when the weighted average value FAFAV has not been updated) is separately counted by the ECU 100 using a counter. When the count value exceeds a predetermined number, the ECU 100 determines that the main FIB learned value KG has converged. In other words, the ECU 100 determines that the learning has been completed.

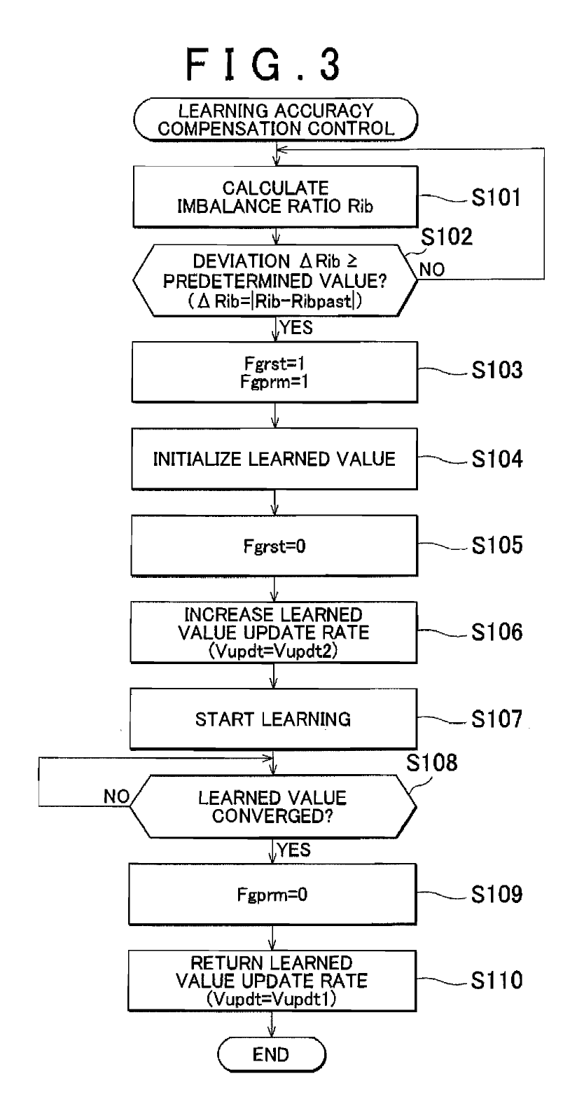

Next, description will be made in detail of learning accuracy compensation control performed by the ECU 100 with reference to FIG. 3. FIG. 3 is a flowchart showing the learning accuracy compensation control.

As shown in FIG. 3, the ECU 100 calculates an imbalance ratio Rib in the air-fuel ratios of the cylinders 201B (step S101).

The imbalance ratio Rib in air-fuel ratios means a degree of variation in air-fuel ratio of the air-fuel mixture among the cylinders 201B, and is an example of “imbalance degree” according to the invention. More specifically, the imbalance ratio Rib according to this embodiment is a ratio between a maximum value and a minimum value of the upstream air-fuel ratio A/Fin calculated for each of the cylinders 201B based on the output voltage Vafin of the upstream air-fuel ratio sensor 216. It should be understood that this is only an example of the degree of imbalance according to the invention, and a practical form of the degree of imbalance is not restricted as long as it can represent a degree of variation in the air-fuel ratio among the cylinders.

The intake port injectors 211 of the cylinders 201B do not always have a uniform fuel injection amount Q in response to a drive signal, due to their individual differences, temporal change or the like. Basically, such variation is often not so significant as to pose a problem. However, when some change occurs in an intake port injector 211 corresponding to a specific cylinder, the fuel injection amount Q in this specific cylinder may become significantly different from the fuel injection amounts of the other cylinders. The imbalance ratio Rib can be used effectively as an index to detect such variation that has occurred in the fuel injection device.

The ECU 100 continuously updates the imbalance ratio Rib by calculating the imbalance ratio Rib at every predetermined timing. Such updating of the imbalance ratio Rib is also performed as a kind of the learning processing. The ECU 100 always holds in its RAM the latest learned value relating to the imbalance ratio Rib.

Once the imbalance ratio Rib is calculated (more specifically, once the imbalance ratio Rib is updated by the learning processing), the ECU 100 calculates an imbalance ratio deviation ΔRib according to the following formula (8):

ΔRib=|Rib−Ribpast| (8)

where Ribpast denotes a final learned value relating to the imbalance ratio Rib in the previous trip. The imbalance ratio deviation ΔRib serves as an index to indicate how much the imbalance ratio Rib differs between in the previous trip and in the latest trip (that is, how much the state of the exhaust gas in the exhaust pipe differs between these trips).

Upon calculating the deviation ΔRib, the ECU 100 determines whether or not this deviation ΔRib is equal to or greater than a predetermined value (step S102). If the deviation ΔRib is less than the predetermined value (NO in step S102), the ECU 100 returns the processing to step S101. This predetermined value is a design value.

If the deviation ΔRib is equal to or greater than the predetermined value (YES in step S102), the ECU 100 sets an initialization flag Fgrst to “1”, while setting a learning acceleration flag Fgprm to “1” (step S103).

The initialization flag Fgrst assumes a value of “0” or “1”, and “1” is a control flag that indicates that the learned value relating to the air-fuel ratio F/B control (that is, the main F/B learned value KG and the sub F/B learned value Vfbsl) should be initialized. The learning acceleration flag Fgprm assumes a value of “0” or “1”, and “1” is a control flag that indicates that the update rate of the learned value relating to the air-fuel ratio F/B control should be increased. This means that, according to this embodiment, when the deviation between the imbalance ratio Rib in the previous trip and the imbalance ratio Rib in the latest trip is equal to or greater than the predetermined value, the ECU 100 is prompted to initialize (or to discard) the learned values relating to the air-fuel ratio F/B control and to accelerate the learning.

The ECU 100 initializes the learned value (step S104), and returns the initialization flag Fgrst to “0” (step S105). Subsequently, the ECU 100 sets the learned value update rate Vupdt to Vupdt2 that is greater than a standard value Vupdt1 to accelerate the learning in the air-fuel ratio F/B control (step S106).

Once the learned value update rate Vupdt is set to Vupdt2, the ECU 100 starts learning of each learned value at the learned value update rate Vupdt2 thus set (step S107). In this embodiment, increasing the learned value update rate Vupdt corresponds to increasing the value p in the formula (6) above. However, practical procedures to increase the learned value update rate are not limited to such change of the coefficient. For example, the update rate also can be increased by accelerating the calculation cycle, or by learning every several samples.

The ECU 100 determines whether or not the learned value has converged (step S108). The determination of convergence of the learned value in this embodiment is performed, as described above, based on the number of times when the weighted average value FAFAV of the main F/B control amount FAF has fallen within the prescribed range. When the learned value has not been converged (NO in step S108), the learning is continued.

In contrast, when the learned value has converged (YES in step S108), the ECU 100 sets the learning acceleration flag Fgprm to “0” (step S109), so that the learned value update rate Vupdt is returned to Vupdt1 (Vupdt1<Vupdt2) as the standard value (step S110). Once the learned value update rate Vupdt is returned to the standard value, the learning accuracy compensation control ends.

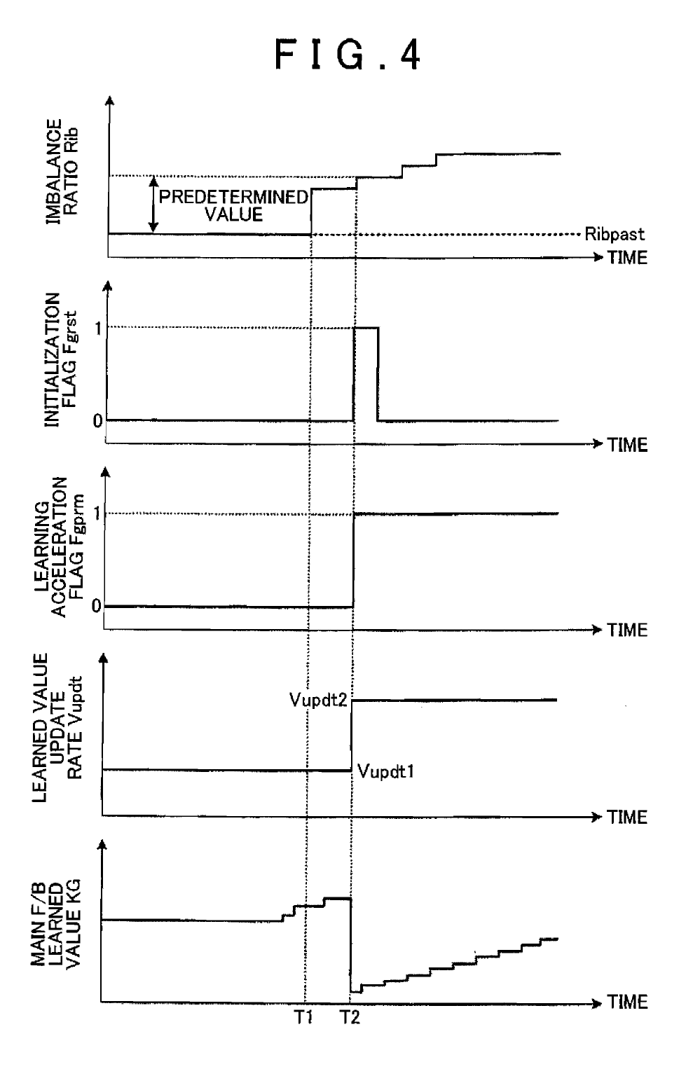

Referring now to FIG. 4, the learning accuracy compensation control will be described visually. FIG. 4 is a timing chart showing, by way of example, time transition of each of the control values in the learning accuracy compensation control.

FIG. 4 shows, beginning at the top, time transition of the imbalance ratio Rib, the initialization flag Fgrst, the learning acceleration flag Fgprm, the learned value update rate Vupdt, and the main F/B learned value KG.

It is assumed that the imbalance ratio Rib starts to deviate from the value Ribpast in the previous trip at time T1 for some reason, and the deviation ΔRib becomes equal to or greater than the predetermined value at time T2.

In this case, the initialization flag Fgrst and the learning acceleration flag Fgprm are both set to “1” at time T2, and the main F/B learned value KG is initialized (though not shown, the learned value Vfbsl relating to the sub F/B control amount Vfbs is initialized as well).

In a time domain after the initialization of the learned value (after time T2), the learned value update rate Vupdt is switched from Vupdt1 to Vupdt2, so that accelerated learning is started. As a result, the main F/B learned value KG promptly starts converging to a new convergence value.

According to the learning accuracy compensation control according to this embodiment, as described above, when the imbalance ratio Rib, which is a degree of imbalance in the air-fuel ratio among the cylinders, has varied by the predetermined value or more from the imbalance ratio Rib in the previous trip, the previous learned value is discarded and, after the discard of the learned value, accelerated learning (at an increased update rate) is started.

It is considered that when the imbalance ratio Rib has varied by the predetermined value or more, the state of exhaust gas in the space in the exhaust pipe 214 where the upstream air-fuel ratio sensor 216 is arranged has also changed relatively significantly. If the learning is only accelerated while continuously using the previous learned value in such a state, this previous learned value that has already lost its validity may possibly delay the convergence of the learned value (see the behavior of the learned value from time T1 to T2 in FIG. 4). When there is not any significant difference between the previous learned value and the true learned value to which the learned value should be caused to converge by new learning, accelerated learning may possibly cause the learned value to converge to a wrong convergence value different from the true learned value. In either case, the delayed convergence of the learned value (delayed completion of learning) will lead to deterioration of the exhaust gas cleaning efficiency of the three-way catalyst 215, which adversely affects the emission control.

In contrast, when the learned value is initialized before acceleration of the learning, as is in this embodiment, there is a sufficient difference between the true learned value and the initialized learned value (initial value). Therefore, the effect of accelerating learning can be fully exhibited, while avoiding undesired delay in learning. This means that, the deterioration of exhaust gas cleaning efficiency can be prevented as much as possible.

Additionally, in the air-fuel ratio F/B control in related art, no consideration is given to the imbalance ratio Rib in the air-fuel ratios of the cylinders. Therefore, no matter how much the imbalance ratio Rib has varied with respect to the imbalance ratio Rib in the previous trip, the learned value in the previous trip is not discarded. This is because the learning processing itself is functioning normally, and the learned value in the previous trip is not an abnormal value. In this respect, it has been found by the inventor of the invention that a change in the imbalance ratio Rib affects the learning in the air-fuel ratio F/B control. Based on this finding, in this embodiment, the previous learned value is discarded by using the imbalance ratio Rib as a criterion. Thus, this configuration is evidently more advantageous in comparison with any of the control methods in related art in terms of convergence rate and convergence accuracy of the learned value when the imbalance in the air-fuel ratio becomes too obvious to be neglected in practice.

It should be understood that the invention is not limited to the above-described particular embodiments but various changes and modification may be made without departing from the scope of the invention as defined in the appended claims and the specification as a whole. Thus, a control apparatus for an internal combustion engine including such changes or modifications also falls within the technical scope of the invention.

The invention is applicable to control of any internal combustion engine in which the air-fuel ratio F/B control is applied to control the fuel injection.

What is claimed is:

1. A control apparatus for an internal combustion engine, comprising:
at least one air-fuel ratio detection unit arranged in an area of an exhaust passage, in which exhaust gas from a plurality of cylinders of the internal combustion engine is collected;
a feedback control unit configured to determine a fuel injection amount for each of the plurality of cylinders by performing predetermined air-fuel ratio feedback control including feeding back an air-fuel ratio detected by the at least one air-fuel ratio detection unit to the fuel injection amount using a feedback control amount;
a learning unit configured to learn the feedback control amount relating to the air-fuel ratio feedback control so as to obtain a learned value relating to the feedback control amount, and to update the learned value at an update rate;
an estimation unit configured to estimate a degree of imbalance in the air-fuel ratio among the plurality of cylinders based on the detected air-fuel ratio;
an initialization unit configured to initialize the learned value when a deviation between the estimated degree of imbalance and a previous value of the estimated degree of imbalance is equal to or greater than a predetermined value; and
an update rate change unit configured to increase the update rate, relative to a standard value of the update rate after initialization of the learned value.

2. The control apparatus according to claim 1, wherein the internal combustion engine includes an exhaust gas cleaning device that is arranged in the exhaust passage and cleans the exhaust gas, and the air-fuel ratio detection unit is provided in plurality, at least one of the air-fuel ratio detection units being arranged upstream of the exhaust gas cleaning device in the exhaust passage, and at least one of the air-fuel ratio detection units being arranged downstream of the exhaust gas cleaning device in the exhaust passage.

3. The control apparatus according to claim 1, further comprising
a determination unit configured to determine whether or not the learned value has converged, wherein the update rate change unit returns the update rate to the standard value when the determination unit determines that the learned value has converged.

4. A control method for an internal combustion engine, comprising:
detecting an air-fuel ratio of exhaust gas in an area of an exhaust passage, in which the exhaust gas from a plurality of cylinders of the internal combustion engine is collected;
determining a fuel injection amount for each of the plurality of cylinders by performing predetermined air-fuel ratio feedback control including feeding back the detected air-fuel ratio to the fuel injection amount using a feedback control amount;
learning the feedback control amount relating to the air-fuel ratio feedback control so as to obtain a learned value relating to the feedback control amount, and to update the learned value at an update rate;
estimating a degree of imbalance in the air-fuel ratio among the plurality of cylinders based on the detected air-fuel ratio;
initializing the learned value when a deviation between the estimated degree of imbalance and a previous value of the estimated degree of imbalance is equal to or greater than a predetermined value; and
increasing the update rate, relative to a standard value of the update rate after initialization of the learned value.

5. The control method according to claim 4, further comprising:
determining whether or not the learned value has converged; and
returning the update rate to the standard value when the learned value is determined to have converged.
